(19) United States
(12) Patent Application Publication
(10) Pub. No.: US 2015/0298953 A1
(43) Pub. Date: Oct. 22, 2015

(54) MULTIFUNCTIONAL 21-IN-1 OPENER

(71) Applicant: José Ercio ROCCHI, (US)

(72) Inventor: Ricardo Rocchi, Sao Paulo (BR)

(21) Appl. No.: 14/434,966

(22) PCT Filed: Oct. 9, 2013
(86) PCT No.: PCT/BR2013/000407

§ 371 Date: Apr. 10, 2015

(30) Foreign Application Priority Data
Oct. 11, 2012 (BR) BR 20 20120262016
Oct. 26, 2012 (BR) BR 20 20120275916
Dec. 4, 2012 (BR) BR 10 20120309513
Mar. 19, 2013 (BR) BR 10 20130154342

(51) Int. Cl. B67B 7/14; B67B 7/18; B67B 7/40; B67B 7/16

(52) U.S. Cl. CPC B67B 7/14; B67B 7/16; B67B 7/184; B67B 7/403

(57) ABSTRACT

“MULTIFUNCTIONAL OPENER 21 IN 1”. Beverage can seal opener produced in plastics, elastomers, silicones, rubbers and other polymers shaped as elliptical elongated tubes (3), FIGS. 1A, B, C, and enlarged enough to vest the seal 7, or in another geometrical shape, FIG. 9 to FIG. 11, or hexagonal and in other geometrical shapes. It has measured thickness, hardness and flexibility 8 scaled to optimize and facilitate its introduction 10 in the seal 7, in order to open (11) the beverage can (5); its biggest differentiation and innovation is its unprecedented flexibility (8), which easily overcomes the existing unevenness (9) between the rim of the can (5) and the beginning of the seal (7), without the need to push to introduce it and its body (1) being the lever (12) itself, and also being an opener of metallic and plastic threaded lids, having sufficient stiffness to open the seal of beverage cans (5), and sufficient flexibility to be able to involve the threaded lid and optimize and support its opening, FIG. 7, FIG. 8 or FIG. 14, and also being an opener of sachet formed by the same opener body hole when it is hollow 4 or massive with the hollow ends, using a beverage can seal (7) within it for that, FIG. 16, or a fixed blade, FIG. 15 and FIG. 19, and being a lid opener of glass bottles when used as keychain, FIG. 24, using a seal (2J) from the can (5) 20 and FIG. 21 and also being a multi-tone whistle FIGS. 22A and an anti-stress FIG. 23, and having a total of 11 efficient functions in its body, having an inventive property, industrial application, and being unprecedented in the world “And becoming a great functional and technological innovation.”

The object of this patent invention is a Multifunctional opener with 11 functions, which has unity of invention with patents BR 20 2012 026201 6, BR 20 2012 027591 6, BR 10 2012 030951 3, and BR 10 2013 015434 2. Adding up to a “Beverage can seal opener, plastic and metal bottle lids opener, threaded sachets of seasoning with the seal of the can or fixed blade, bottle opener lids of glass bottles (with the can seal and with inverted L-shaped heart ring or special lever), whistle that emits various sounds and musical notes which can be squeezed in multiple locations or folded, and may also be a new musical instrument, with anti-stress function because it is soft and has memory, locker, beverage can marker, because it gets stuck in the seal and has several colors or themes in order to be identified, pendant opener for jacket and backpacks zipper.

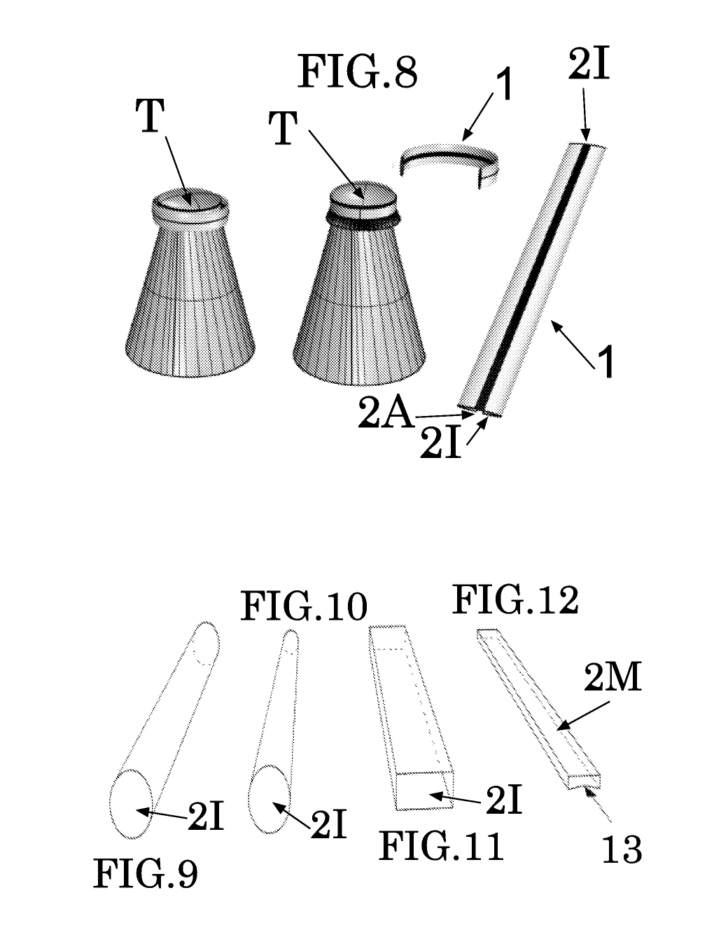

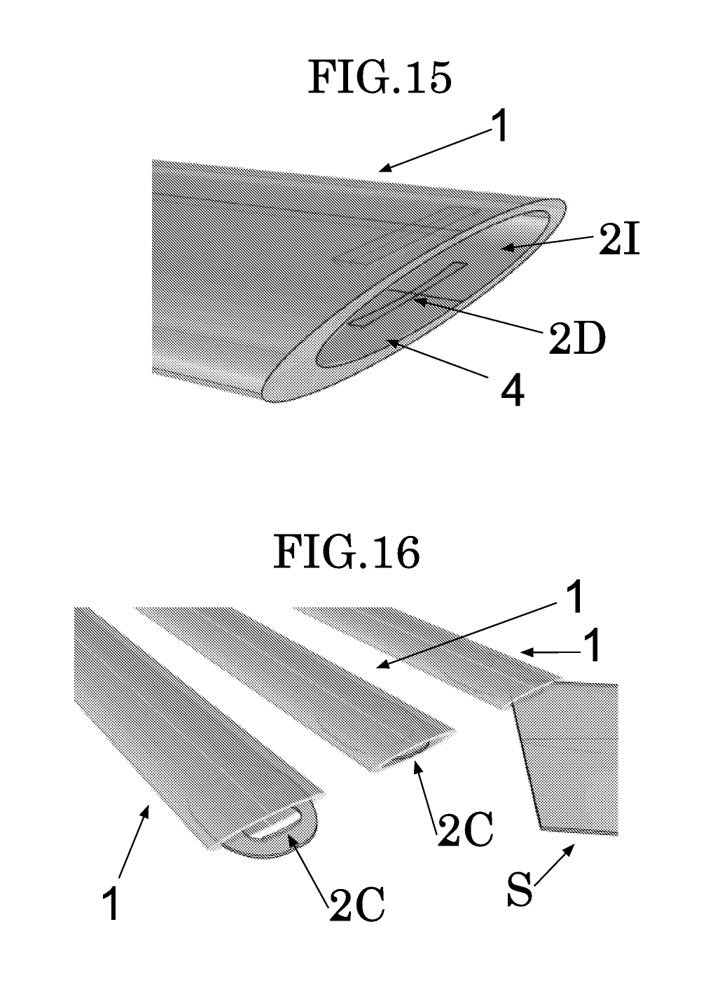

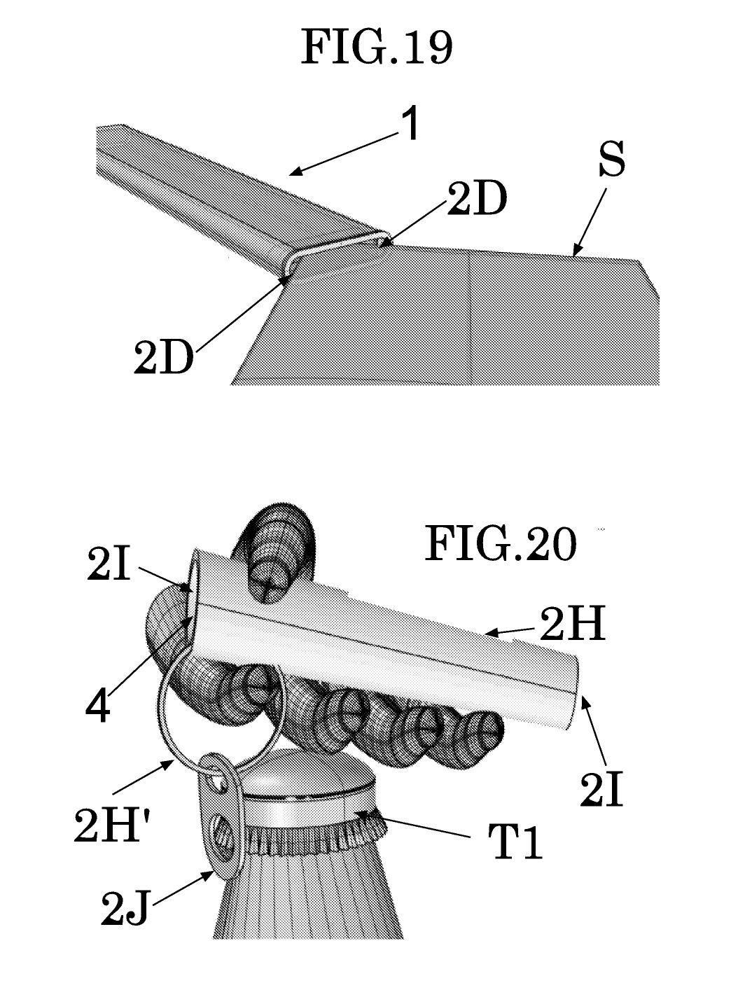

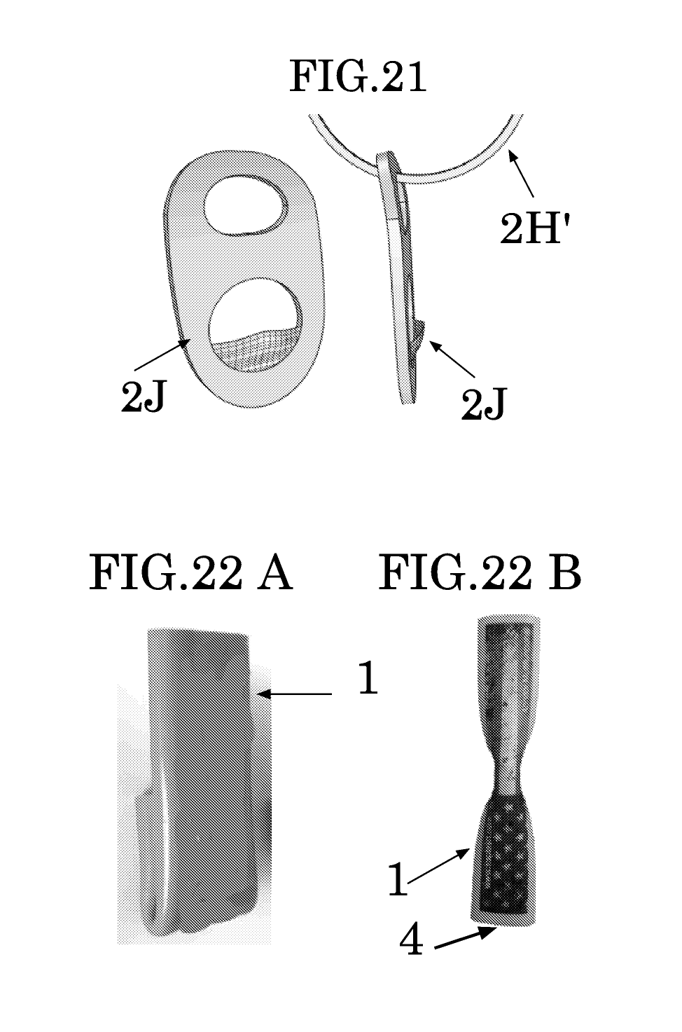

All that using the body of the seal beverage opener itself, which added have 11 functions altogether, serving to open threaded plastic and metal lids FIG. 7 and FIG. 8 in its own body, having thicknesses, hardness, and flexibility adapted to that, which is its biggest differentiator and innovation, also functioning as an opener of seasoning sachets, FIG. 16 using the seal of beverages itself that was extracted from the can as a blade for opening sachets of seasoning, or even may be already manufactured with a micro blade made of metal, ceramic, or other hard plastic that can be coupled to it, FIGS. 15 and 19 already in the injection process, or be adapted after the extrusion, which also serves as glass bottles lid opener with a beverage can seal hanging on the keychain ring FIG. 20 and FIG. 21 reaching up to 11 functions.

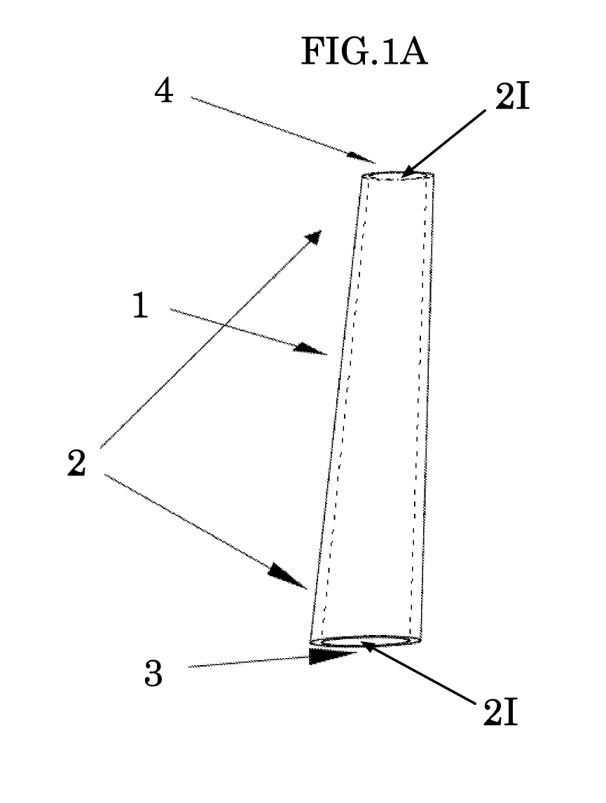

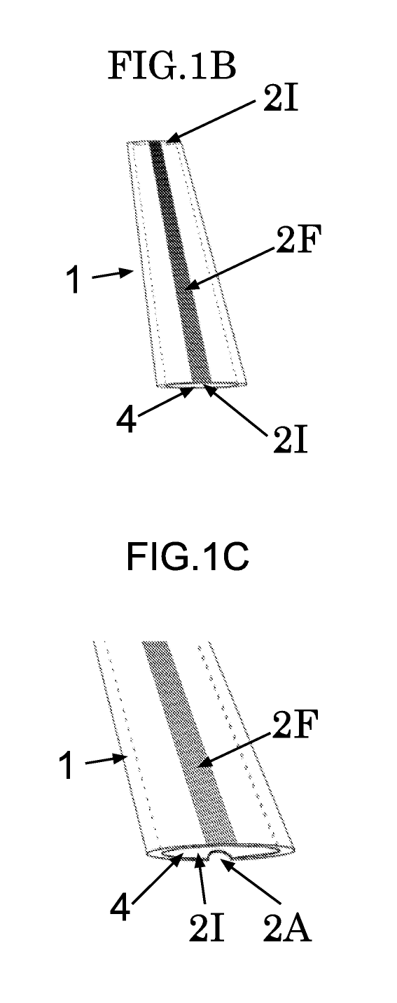

The characteristic of the can seal opener is determined by an elliptical tubular 3 format stretched and widened enough to put on the seal 7 of the can 5, being enough to exceed the length of the seal 7, having scaled measures to optimize and facilitate its introduction into the seal. It further presents a great and unheard of differential that is its operating mechanism, consisting of its high flexibility 8, enough to easily overcome the unevenness existing between the rim 9 of the can 5 and the beginning of the seal 7 without forcing the seal at the moment which is docked positioned to open it, at the time of its introduction, 10 and may have even an indentation 2A at the bottom of the can opener FIG. 1C in order to be introduced more deeply without being hindered by the rivet 6, or can have a curved tip 2B FIG. 13 which also helps the opener to pass over the rivet 6 or not FIG. 1A, being that it is not necessary because it is efficient without it. Moreover, as the opener can easily remove the seal 7 of the can physically with repeated moves made towards opening and opposite to it, you can leave the seal stuck internally to the opener that is constructed with measures for it, being slightly stuck to the seal. And, as at the time we broke the seal off removing it from the can, it is deformed in the part that breaks, forming a blade opposite the direction of lifting the part of the seal, when it breaks forming a sharp surface of more or less 0.5 mm at this location, and so when we deepen the seal inside the opener until the blade (sheared and sharp part) passing 1 mm inside it, that micro blade turns into a sharp blade 2C enough for opening the seasoning sachet S, because when we flushed out the corner of the sachet in the opener between the seal with the sharp part (sharp blade 2C) and the plastic surface, just squeeze the opener by pressing the sachet S against the sharp part of the seal which was sheared from the can to open the sachet S easily, because the blade 2C holds the sachet S when we pull with the other hand and it cuts the tip of the sachet S at that moment, FIG. 16, for when the material from the sachet S is squeezed, it gets stuck and cuts due to the sharp resistance made in that place from the pressure exerted by the flexible opener on the blade. Cutting the sachet S in its tip where there is almost no product, it is possible to not leave the opener and the blade dirty. Therefore, it becomes even super hygienic because the opener can be disposable to be used only once or be of personal use, where you even wash it when you wash your hands. The sachets opener can be made also with a micro blade 2D of plastic, ceramic, metal or other sharp materials, already embedded in it at the time of its manufacture, and for security this blade can have a small length that does not pass to the other side of the opener, and yet the other side having a recess so that it is securely attached when it is tight to open the sachet. FIG. 15 or like FIG. 19 or can even be already distributed with a recycled seal, sterilized in autoclave, within the very opener or not. Optionally, the blade of the present opener can be adapted in a variety of ways and sizes, such as shown in FIG. 20, where the blade is defined by the very sharp rim 2D generated when manufacturing the present opener.

The opener can be used several times and can be transparent to provide improved hygienic visualization from inside or not.

The general characteristics of this multifunctional opener is having his body made on elastomer, flexible plastic, silicone, rubber or other material with sufficient strength to open the seal of beverages and flexibility to be able to engage the threaded T lid for its opening, and to have shape and fair measures so that the seal can be stuck and fit inside its body, slightly locked to function as blade for the opener of S sachets, and be soft enough to become a protection to be a T1 lid bottle opener with the beverage can seal FIG. 20 and have flexibility and memory to be an anti-stress appliance, and flexibility and scalability needed to become a whistle with multiple sounds that can be a new musical instrument.

The feature of operation to open seals 7 of beverage cans FIG. 1 to FIG. 6 is having thicknesses, hardness and flexibility needed 8 to perform its function of lever 12 with excellence, having a hollow tubular format 4 ellipsoidal 3 flexible 8 and long with round edges or other similar geometries FIG. 9 to FIG. 11, so that it is easy to be introduced (fitted) in the seal because it almost does not force the seal trying to lift it at the time of its introduction, being a unique operating mechanism, because it overcomes the unevenness 9 of the can 5 rim with respect to the beginning of the seal 7 without the need of efforts with lightness and great functionality. It may also be massive 2M as a spatula that also has the flexibility to open threaded lids of beverage bottles FIG. 12 and may have a recess 13 to pass over the seal and lock behind it at the time of it lifting or not. Moreover, can be further a massive piece in its mean with an indentation on one of the sides or on both sides, scaled so that the beverages seal is introduced there.

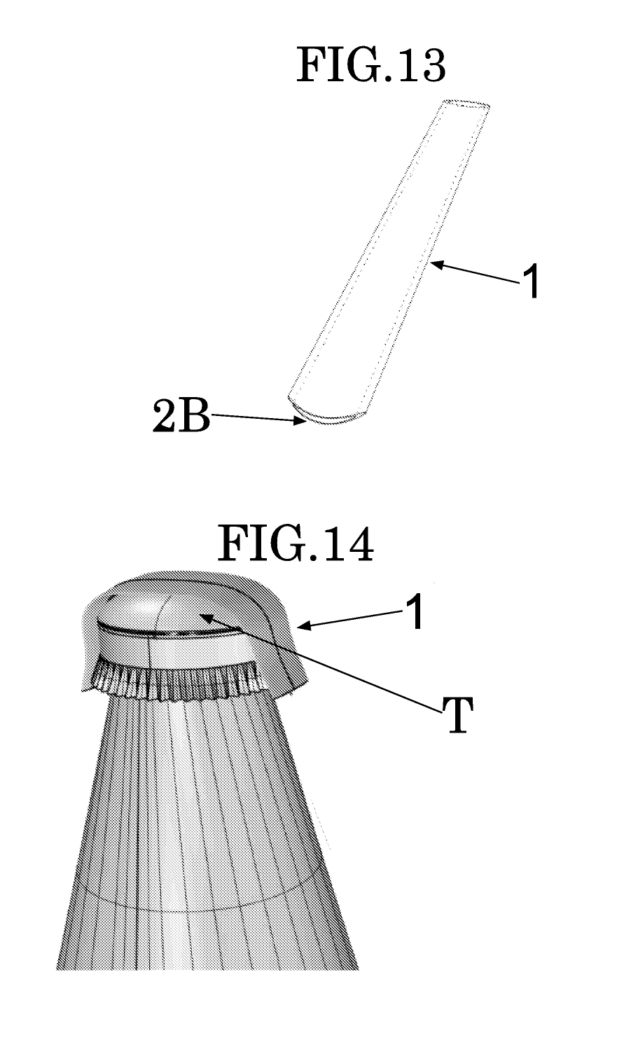

The feature of its operation to open T threaded lids is as follows: hold the opener backed on one side near the tip of the thumb and the other side propped up around the tip of the index finger, and press on the lid until the opener bends and wraps it, then you hold it firmly and rotate the T lid for its opening FIG. 7 and FIG. 8, or IT can also open from the top, and thus have a reduced length FIG. 14, and then just fold it to engage the T lid FIG. 7 and FIG. 8 and FIG. 14 and turn it on the part that makes contact with the T lid, which can still have a differentiated softness area 2F (with hardness lower than 80 Shore A) FIG. 1B or be all wrapped up in this soft material FIG. 18 with or without grooves 2G, and there might be materials different softness in the same opener in order to provide greater firmness on when holding it with the fingers not to slip, and the prototype and our production fit very well with only one raw material. Its use protects the user's hand, because it is manufactured with a comfortable material that is in contact with the hand and fingers and is flexible enough to adhere and lock in the threaded T lid when squeezed over it, and it can be manufactured with one or more materials.

The feature of the operation of the sachets opener is working as an opener of seasoning sachets S, which uses the can seal itself as a sharp blade 2C that was extracted from the beverage can to open ketchup and seasoning sachets S, becoming an ecological opener FIG. 16 and giving a new utility to beverage can seals, and can be use seals that come already protected by an aluminum seal (lid) or seals which are clean, sterilized or washed appropriately by their users, or using the micro blade 2D which can be already fixed to it. FIG. 15 and FIG. 19, or optionally, the blade of the present opener can be adapted in a variety of ways and sizes, such as shown in FIG. 19, where the blade is defined by the very sharp rim 2D generated when manufacturing the present opener.

The characteristic of being also a whistle is that when we close the bottom part or squeeze it or bend it somewhere on its body to close it as FIG. 22A and 22B (folded) due to its flexibility, and we blow in its nozzle as blowing hard at the nozzle of a Bolivian flute or a bottle, adjusting the angulation of the blow by hit and miss, and it turns into a very loud whistle and even into a musical instrument, due to the fact that we can squeeze it in various locations and different distances from where we blew quickly, producing different sounds and musical notes in each place we squeeze.

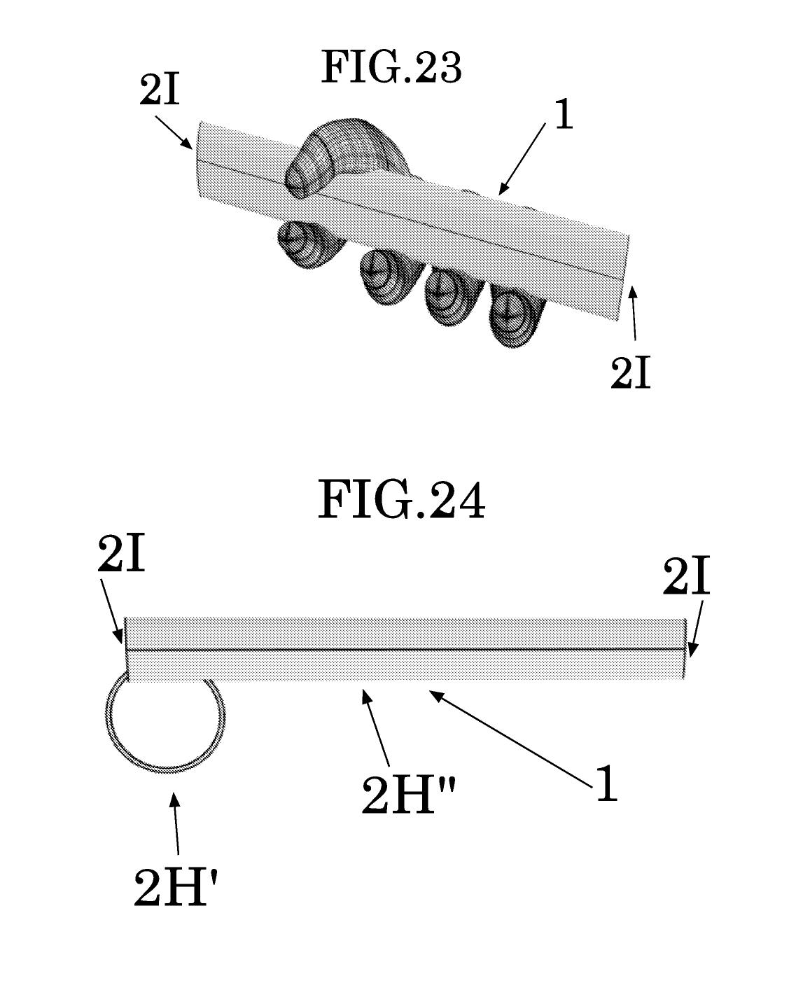

The characteristic of being an anti-stress appliance is due to being manufactured in a flexible material and good to tighten and with memory, so it can be tightened and return to its initial position numerous times turning into an anti-stress appliance FIG. 23.

The characteristic of being a locker 2H FIG. 24 is due to be able to place a ring 2H in it which in turn allows the function of bottle lids opener for glass bottles with the can seal FIG. 20 and FIG. 21.

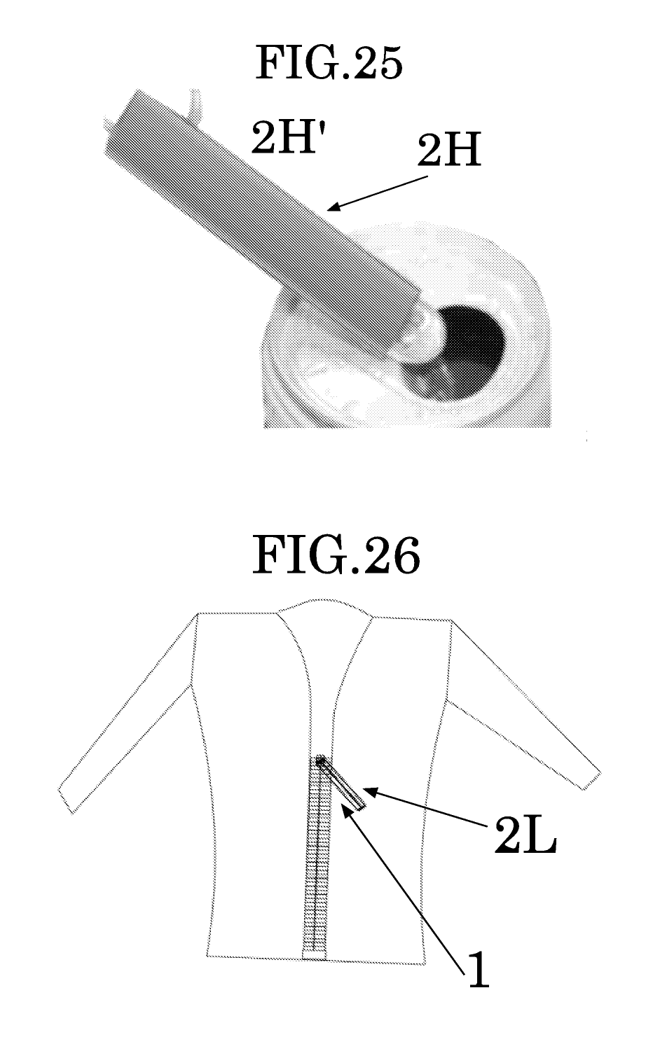

The characteristic as a marker of cans happens when we open the beverage cans and the opener is stuck in the can seal, with the seal facing the opposite side that we drink without any hindrances, as when it is introduced into the seal it is stuck in it with a certain pressure (to also be able to help take the seals off the can, and to open the sachets S efficiently without slipping the seal at that time). Therefore, having several colored or patterned openers with various themes, names, flags, etc. it can determine to whom each beverage can belongs at a party FIG. 25.

The characteristic for a pendant of zipper (zip fastener) is that its format is similar to a pendant and can serve as a (zip fastener) of zipper 2L with several of the functions described herein as beverage can seal opener and long necks® anti-stress, ideal for enjoying nights out, etc. FIG. 26.

And all these functions are performed by a simple small tube with dimensions, hardness, thicknesses, and flexibility necessary for that, and everything that makes a functional innovation, which is easily transformed into a product because it has economic importance and can provide greater competitiveness to a multifunction product that has now 11 functions, where it has been manufactured physically in PVC and in Styroflex® (elastomer) from Basf® (SBS) and has approximately 0.5 to 2 mm (being that the ideal tested was of +or −1 mm) of wall and hardness of 80 to 95 Shore A to a nozzle 21 of +or − approximately 17 mm external width (can be wider or narrower to measure different seals if required) by 8 mm +or − of internal or external height, and 4 mm internal +or − in length approximately which can range from 40 mm to 95 mm or more, for better efficiency approximate measurements and must have dimension to involve can seal in order to open it and flexibility to engage the threaded lid T and open it and be able to perform all the other functions. Weighing 2 to 10 grams more or less, depending on which function you want to optimize, and may be longer so it can be a longer straw and a whistle that plays various tones if turned into a musical instrument with more sounds, or shorter to optimize other functions.

This invention has inventive property and is unprecedented throughout the world, having the characteristics of absolute novelty (there is no product like it in the market) because it is an opener that besides having 11 functions (in a single object) is a “long neck®” beverage can lid opener, as well as for seasoning sachets S which features a never-before-seen technical advancement.

And this product is not known in the body of existing knowledge called state of the art, and is an inventive activity that has industrial applications, i.e., it can be produced on a large scale (by extrusion) 1 machine produces 50,000 openers per day.

I have researched and found no opener, which is its main function, which uses its own body to open beverage cans, threaded bottles lids, and sachet opener as mine does. However, I have found beverage can seal openers and threaded lids openers, and ketchup seasoning sachets openers that is different in their operating mechanism with respect to mine and, when comparing them to mine, I found a few drawbacks in them.

In this research, I found beverage can seal openers that work differently from mine.

One is made by a rigid metal rod to be introduced by means of an existing hole in the seal, to make its opening and, on the other side, has a regular glass bottle lid opener.

And another that is international, just to open can seals, made from hard metal to be introduced under the seal and force its opening, having some animals drawing and others being more of a locker; still have found another seal opener that has its construction made in hard plastic, and has a hole made in metal to introduce into the seal, and another one that is formed from a rod and has a kind of a hook in its tip, and another threaded bottle lids opener, which is like a silicone lid that fits on the outside of the lid to protect your hand.

I have researched and found some beverage can seal openers with very different operating mechanisms from my opener, and compared mine to their individual functions, and found some shortcomings and some drawbacks in them.

Since the use of any of these openers analyzed for opening cans is still better than using the nail itself, but it does not eliminates the risk of ingesting aluminum that is comes off at the time of its introduction in the can and due to the disproportionate force that is required to be introduced due to the lack of flexibility.

When I have analyzed the opener that is made by a hard metal rod that passes through one of the holes in the seal to make its opening, I have found that this ends up having its use restricted because many beverage cans today are being manufactured without the hole in the seal, and there is yet another problem in this opener, because as it is made of metal ends that when introduced into the hole, scrape the seal and the can, leaving aluminum particles that eventually could be ingested by the user, making it harmful to our health. And also cannot be disposable, because they are made in a more expensive way. And is also a very big and heavy object compared to simplicity and technical achievement contained in mine, where a simple dimensioned and flexible little tube carries all these functions, plus 10 for a negligible production cost with an inexpensive productive cost.

In the other can opener that I have found on the market, which is also made of hard metal, and has to be forcibly inserted underneath the seal due to its lack of flexibility, taking into account the existing unevenness between the seal and the rim of the can, making it difficult to use and introduce, as well as slipping laterally (different from mine that uses the seal as a rail because when it touches the edge of the seal it is already fit directly because the seals are circular in their tips and that causes it to even if fit in off-center it is adjusted to the center due to hitting on the edge of the opener and being guided to be fitted. And this opener that I have analyzed also presents propensity besides being hard to fit, to scrape and loosen aluminum particles due to higher friction exercised in the can and on the seal. In addition, they cannot be disposable, because they are made in a more costly way than mine, with a single function.

There are also other openers, which have its hard plastic and metal construction in the part of the hole, which it introduce into the seal, and this metal is needed to withstand the pressure in its tip at the time of the beginning of its introduction into the seal due to its lack of flexibility and its thin and rigid wall. This is necessary due to the unevenness between the rim and the beginning of the seal. They also do not meet the required demands, as they are also introduced forcibly into the seal due to the lack of flexibility, since, when we push to enter into the seal, they are already trying to raise it because of the existing uneven angle between the seal and the rim of the can, and with this, they also scratch and leave off particles of aluminum due to its metal part being in touch and making friction with the seal of the can. Being that there are also hard plastic in its tip, that does not have the disadvantage of scraping the aluminum, but has little durability due to forcing the hard plastic, which cracks more easily when forced with the thin wall. In addition, they cannot be disposable, because they are made of a more costly way and have only one function.

There is also an opener that is a rod and has a kind of a hook on its tip, and that also ends up releasing aluminum particles due to its metal tip scraping the seal and the can. In addition, they cannot be disposable, because they are made in a more expensive way.

And there is a metal lid opener, which is made in the shape of the greater lid to fit it as a snap-on socket wrench and only serves to metal lids, not being suitable for threaded plastic lids or can seal opener or sachet opener or ice cream spoon, or whistle and anti-stress object, and marker of cans and not to the other functions described herein and that also cannot be disposable, as it is manufactured in a more expensive way.

And the inconvenience of sachets opener that I have met for collective use is to stay with a sticky and suspicious aspect from an hygienic point of view, shortly after its first use, because I have realized that after opening a ketchup earlier in the day the opener is sticky and unusable visually from the visual and hygienic point of view, because as soon as a user opens a sachet of mayonnaise or ketchup and a mustard sachet at 8:00 in the morning it gets filthy, attracting flies, bees, and other insects, because the opening is made in the middle of the sachet, where it leaks out and is everything sticky. In addiction, being in non-chilled diners and exposed to the heat in some places from 8:00 a.m. to 10:00 p.m. where several packs have already been opened (if people are brave to put their sachet in touch with that sticky mess), for the site becomes visibly dirty, sticky, and not inviting to use, I even believe that there is a risk of contamination, because they are for collective use, and these can be permanent for single use or disposable and recyclable.

And all these openers do not have the function of threaded metal and plastic lids opener and can seal opener, and sachets opener, and as ice cream spoon, and glass bottles lid opener with the keychain ring in only one product, with all the other functions described herein, much less the innovation of using the body of the same product to serve for these five unreleased functions and also work as a whistle and anti-stress object, as well as can marker etc.

Having in mind these problems and focusing on overcoming them, I went beyond what was predictable and I developed a seal opener for beverage cans,

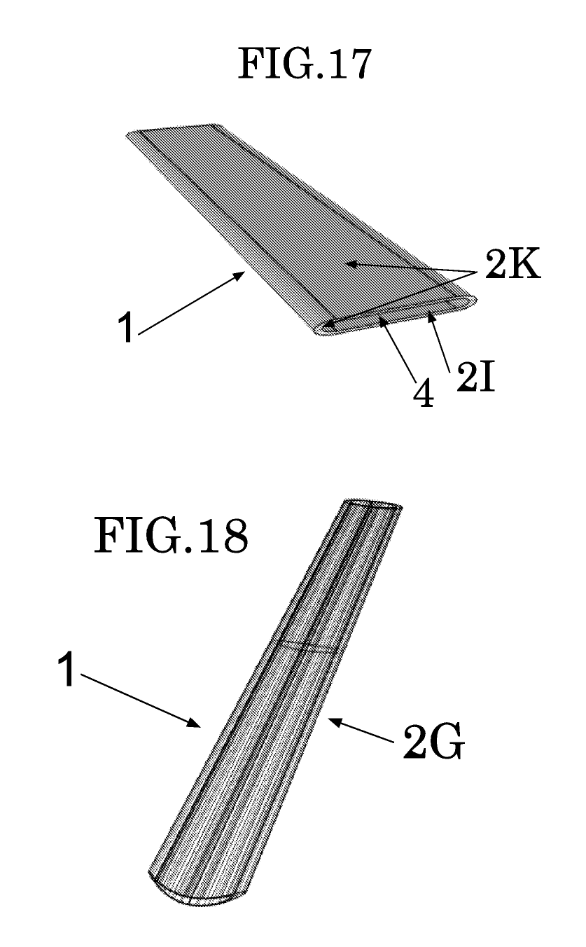

FIG. 1 with thickness and hardness and flexibilities necessary to carry out its function with excellence, having a flexible 8 elliptical tubular 3 format, and rectangular with rounded corners 2K FIG. 17 or other similar geometries for which it is easy to be introduced (fitted) in the seal because it almost does not force the seal trying to lift it at the time of its introduction, being a unique operating mechanism, because it overcomes the unevenness 9 of the can rim 5 with respect to the beginning of the seal 7 with lightness and great functionality. It still has flexibility and practicality to assist the opening of threaded metal and plastic lids due to being made of soft and flexible elastomer, being wrapped in them. Moreover, it may further perform the function of an opener of seasoning sachets that makes use of the can seal itself that was extracted from it to open ketchup sachets, becoming an ecological opener FIG. 16, and giving a new utility to beverage can seals due to its flexibility.

And it may also be disposable or having permanent use, being simple to produce collaborating so that it can be found easily in places that have beverage cans to sell, bottles with threaded lids and seasoning sachets, and where it is needed to know to whom the can belongs, and being able to use it as an anti-stress and as whistle on football stadiums, as in the World Cup etc.

It is manufactured in plastics, elastomers or rubber, or other flexible silicones, and its unprecedented operating mechanism that does not exist in the seal can openers that I have found on the market, scraping in aluminum or other metal cans, and need strength for its introduction, because they are not flexible enough to be made of metal or hard plastic (fragile) or by having metal somewhere to work properly. And it means in more detail that: The bottle opener is made of polymers or elastic plastic so that it does not harm the seal or the surface of the aluminum can, so it does not generate particles of materials that could be swallowed by its users, doing harm to their health, and is made of flexible plastics and elastomers and silicones in its body to enter on seal easily without effort, fitting the seal surpassing the unevenness 9 existing between the beginning of the seal and the rim of the can, and may also be used for opening threaded bottles lids due to its flexibility and can open seasoning sachets with plastic blades or adapted metal can seals (ecological) and lid opener of glass bottles with the keychain ring whistle and anti-stress object, and can marker among its other functions.

It can be made in the form of an elliptical tube 3 or another geometry, for example, rectangle and rectangle with rounded corners 2K FIG. 17 and other, if so preferred geometries, which will not change their unreleased features, and made with fit measures which helps to wear the seal like a glove, and it does not require holes in the seal for its introduction. It is, therefore, easy to use, because its flexibility allows that as soon as we touch the surface of the can 5 with the bottom 2 opener pushing it to fit into the seal, it is bended 8 and starts to fit easily in the seal 7, because at this moment the seal becomes a guide trail, guiding its way, due to the beginning of the seal being mostly curved, without the need of skill or effort to snap it, because due to its calculated plasticity, elasticity, shape and “ability to slide”, it fits the seal without the need to put on any effort, because the seal 7 is practically not raised when introducing the opener 10, and thus, not requiring any effort at that time, providing softness and lightness in its introduction around the seal 7, until the limit depth where it stops on its own, just like automatically, because it reaches the rivet 6 which holds the seal 7 to the can 5.

Only after its introduction, and using its body 1 as a lever 12, we shall force the seal by lifting the opener upwards to open it, and all that and also made with very little effort due to the lever, which can have appropriate measures and thicknesses and calculated flexibility, which provides an excellent efficiency for this 11 in 1 opener of beverage can seal, and due to its softness and flexibility it is also ideal and easy to fit lids for its opening.

Its format in elliptical 3 tube FIG. 1 and elongated and rectangle with rounded corners FIG. 17 is best suited, by involving the seal more appropriately, so that at the time of its introduction into the seal, this format is shaped to fit more precisely to the seal, but it can also be done in tubular form FIG. 9, rectangular FIG. 11, square taper FIG. 10 or any other geometric format, but not as efficient as the elliptical 3 and rectangular FIG. 11 with rounded corners mentioned above, as long as these geometric formats have also special flexibility to fit the seal almost without lifting it, and in some cases being needed to press the opener more in order to get in shape as in the case of cylindrical tubular (that will have to be pushed until the tube enlarges and enters, and for threaded T lid tight until it flattens to shape to the threaded lid.

The opener made in flexible plastic FIG. 1 in the form of elliptical tube 3 FIG. 1A or rectangular rounded at the rims, FIG. 17 in tests was the most suitable for fitting and engaging better the seal more properly, and that can be done with proper and tight measures to fit the seal, all without scraping the aluminum so that the seal is slightly stuck internally in the opener, providing better firmness and control in its opening, and providing even greater security if you want to physically remove the seal from the can for donations or for use in sachets opener S since it is stuck on it, and all this without the risk of the seal falling into the beverage can and without the risk of cutting off the fingers, since these are distant with respect to the sharp corners of the seal and the can by using this opener. And this elliptical shape along with the rectangle shape with rounded corners was very efficient to open T threaded bottles lids, can seals and seasoning sachets S, and lid opener of glass bottles by using the seal 7 as a means of opening the lid, the function referred to seal 7 receives the reference 21. The function now mentioned, analogously to what has been checked against a stapler that needs a clip to be functional, establishes a correlation between the opener and the use of a seal 7 for this set to be functional in order to allow its use as an instrument to uncap a bottle.

And this product can be disposable and permanent and can be available in commercial stores where they sell beverage cans that have seals and where they have bottles with threaded lids, and where there are seasoning sachets to be opened, on parties to work as markers and where there are glass bottles with lids, where if you need a whistle and where you want to relax with anti-stress feature.

The object of this present application will be described with reference to the drawings below, in which:

FIG. 1A shows the “Multifunctional Opener 11 in 1” in ellipsoidal shape in perspective view;

FIG. 1B shows the “Multifunctional Opener 11 in 1” in perspective view in ellipsoidal shape with an indentation in order to fit deeper into the seal surpassing the rivet limit;

FIG. 1C shows the “Multifunctional Opener 11 in 1” in perspective view, manufactured in an ellipsoidal shape with a darker part in the surface manufactured in a softer rubber material in order to better fit the lid and improve adherence when opening threaded lids with an indentation in the shape of a half-moon so it can surpass the rivet 6 of the can 5 and be introduced deeper;

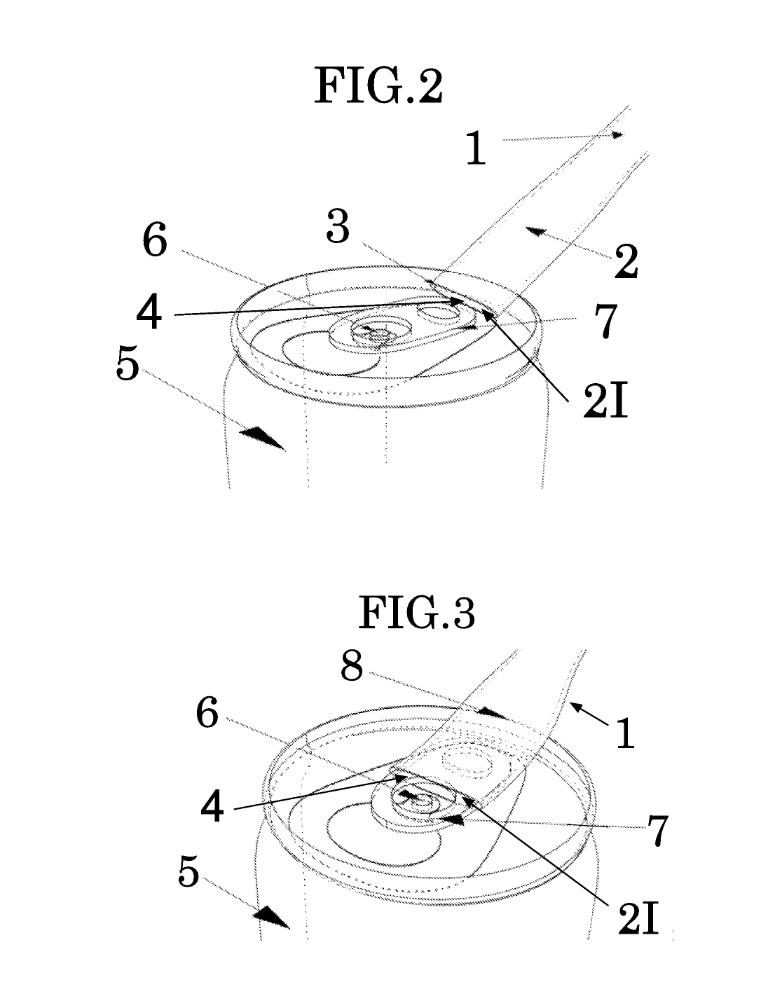

FIG. 2 shows the “Multifunctional Opener 11 in 1” in perspective view before being introduced, over the seal of the beverage can;

FIG. 3 shows the “Multifunctional Opener 11 in 1” through a higher perspective view, introduced in the seal with fit and tight measures;

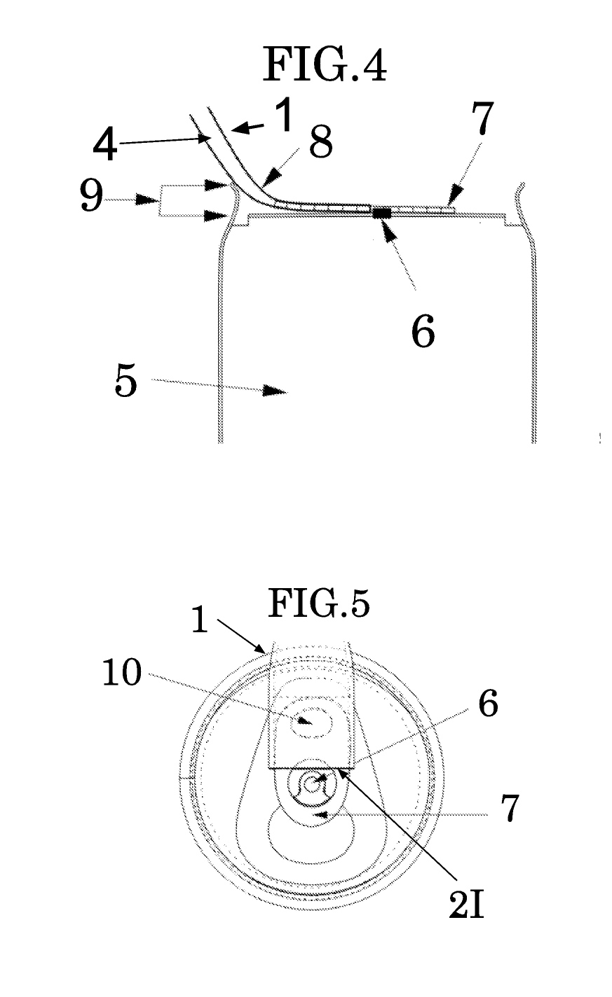

FIG. 4 shows the “Multifunctional Opener 11 in 1” introduced into the seal, in a side view cross section showing its innovative flexibility, which is one of its new operating mechanisms;

The FIG. 5 shows the “Multifunctional Opener 11 in 1” in a top side view introduced into the seal;

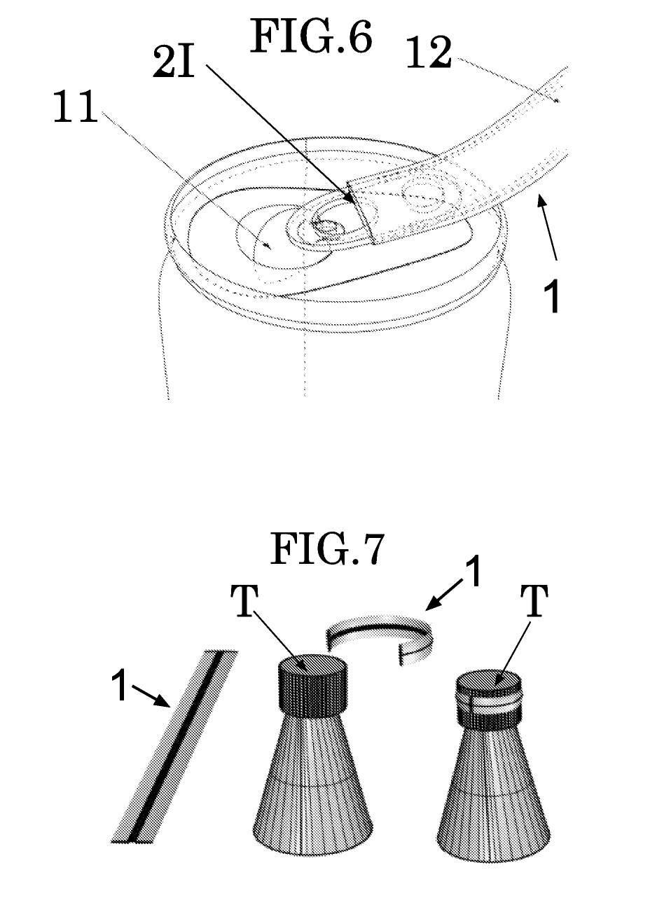

FIG. 6 shows the “Multifunctional Opener 11 in 1” in perspective view starting to open the beverage can due to raising its body “Lever”;

FIG. 7 shows the “Multifunctional Opener 11 in 1” both in a non-bended state and in a bended state and wrapped in a threaded plastic lid to assist its opening;

FIG. 8 shows the “Multifunctional Opener 11 in 1” both in a non-bended state and in a bended state and wrapped in a threaded metallic lid to assist its opening;

FIG. 9 shows the “Multifunctional Opener 11 in 1” entirely cylindrical, where it works as a beverage can opener, as well as “long necks®” and sachets opener;

FIG. 10 shows the “Multifunctional Opener 11 in 1” in a conical shape;

FIG. 11 shows the “Multifunctional Opener 11 in 1” in a rectangular shape;

FIG. 12 shows the “Multifunctional Opener 11 in 1” solid spatula shape with a recess in order to overlap the rivet and lock behind it at the time of raising in order to open the seal, and if it is larger and wider and thicker, it can have holes in its ends so that the seal can be introduced at one end or in both ends, continuing to be a beverage can opener for threaded bottle lids and a seasoning sachet opener;

FIG. 13 shows the “Multifunctional Opener 11 in 1” in perspective view in ellipsoidal shape, with the differential of a bended tip to enter more easily and deeply into the seal due to the greater flexibility of the tip exceeding the rivet 6 over more easily, by bending at that moment;

FIG. 14 shows the “Multifunctional Opener 11 in 1” in perspective view in ellipsoidal shape being placed over the threaded lid to open it and may thereby have nearly half the length than shown in FIG. 7, but not being the most efficient, even having grooves or not;

FIG. 15 shows the “Multifunctional Opener 11 in 1” made with a plastic microblade of metal or ceramic or other material, to open seasoning sachets with recess where it enters to help locking, being that the blade is smaller than the thickness of the other side not to leave out the opener when tightened due to safety reasons;

FIG. 16 shows the “Multifunctional Opener 11 in 1” with a seal of cans inside the opener after being taken from the can in back and forth moves, where there is a sharp part that was sheared and works as an efficient opener for seasoning sachets. A figure with the sharp part of the seal facing up half introduced when we take it out of the can, and one with the seal more introduced so that the sharp part in the opener, and one with the sachet inside, ready to be cut, and it is necessary to tighten the opener for pressing the sachet against the sharp part and pulling it like the ripping of the corner to the middle;

FIG. 17 shows the “Multifunctional Opener 11 in 1” made in rectangular shape with rounded corners;

FIG. 18 shows the “Multifunctional Opener 11 in 1” with the surface covered by a material with different hardness, and can be overlapping, or plain as FIG. 1, or beveled, or with grooves in the direction of its length or towards its width or in other directions;

FIG. 19 shows the “Multifunctional Opener 11 in 1” with a side blade to open sachets where it is necessary to pull or push the sachet towards the blade for its opening, and the blade can be placed in several ways and in different places if desired;

FIG. 20 shows the “Multifunctional Opener 11 in 1” in its function of bottle opener with the beverage can seal, hung on a regular keychain ring, giving new role to seals of beverage cans and being a unique function and an innovation;

FIG. 21 shows the “Multifunctional Opener 11 in 1” in its function of bottle opener with the beverage can seal giving a new role to seals of beverage cans in another angle, showing that as soon as the seal is removed from the can is deformed, creating a convex part that when introduced under one, two, three, or four teeth of the lid, and being raised in the opposite direction of the closing of the lid it lifts the lid effortlessly due to not needing to warp it to open the bottle;

FIGS. 22A and 22B show the “Multifunctional Opener 11 in 1” in its function of whistle, which can be folded as pictured in FIG. 22A, or tightened to close the passage of air in the extension of its body, as depicted in FIG. 22B, generating several distinct sounds, like musical notes, and can become a musical instrument;

FIG. 23 shows the “Multifunctional Opener 11 in 1” in its anti-stress function to be squeezed, for being soft and flexible and having memory;

FIG. 24 shows the “Multifunctional Opener 11 in 1” in its keychain role, with a loop which also serves to hang a can seal or other tool;

FIG. 25 shows the “Multifunctional Opener 11 in 1” in its role as a can marker because it gets stuck in the seal of the beverage can and may thus help to not to mix the cans at a party, when each user uses an opener with color and different designs and leaves it in his/her can, turned back without harming when drinking from the beverage can; and

FIG. 26 shows the “Multifunctional Opener 11 in 1” in its zipper role for jackets and backpacks where in parties, events and/or schools it serves to open cans, threaded lids, open sachets, anti-stress and using other functions.

This invention solves several technical problems that we have when we go for lunch and get a beverage can 5 to be able to drink it and break a nail to open it in the can seal or ruin the nail polish, or when we have a bottle that has threaded lids for opening and hurting our hand, or pierce our shirt or the tablecloth or dish towels and when we take a sachet of seasonings that doesn't open easily and have to bite him forcing the teeth by placing it inside the mouth to open it “unhygienic” or having to pass it in an sloppy opener of sachets, and when we get to open a beverage bottle away from home and we don't have a big heavy opener handy, and when you're at a party and we don't know which is our beverage can, and mix with someone else's, and when we need a whistle for any situation to celebrate or to call someone and don't have it, and when we need to relax and we don't have to anything to squeeze, or for when you're at a party and on our jacket zipper's pendant is an opener, and for when we want to do everything that this patent protects (11 functions) with a simple and portable and almost magical product.

Moreover, it is at that moment that we realize the importance that this product brings in improving our lives. And even for being small and portable we can walk with it in our wallets or card compartment as a locker and so we can still be correctly ecological because we won't spend more with nail polishes and don't ruin you so many more sweaters and tablecloths, sticking them to open threaded metal lids, and many other improvements in our life, only using a simple innovative and technically advanced multifunctional opener 11 in 1.

The present patent invention aims at the beverage cans seal opener, added to threaded T metal and plastic lids opener, added to seasoning sachets S opener added to a simple function of a glass bottle lid opener with a keychain ring and to a whistle and an anti-stress object, and a can marker, and everything else explained herein.

This multifunctional product of 11 roles is an innovation that is easily transformed into a product, and has economic importance and gives greater competitiveness to this product FIG. 1A, 1B, 1C, and FIG. 2 to FIG. 26. This invention has truly many functional innovations.

This bottle opener whistle marker FIG. 1A, 1B, 1C, and FIG. 2 FIG. 26 can:
a) You can minimize the damage made to women's nail polish who would consequently spend less, thus collaborating directly with the decrease in the use of enamels and, consequently, with the health of the planet. In addition, it can avoid skinned cuts and calluses on the hands caused by threaded lids, mainly in the metal ones.
b) It can save the effort for everyone's nails, minimizing possible splinters breaks and pains.
c) It can help young children and the elderly, sometimes they cannot pick the seals 7 of beverage cans 5 and threaded bottle lids.
d) It can save the nails of the waiters who constantly open manually cans 5 seals 7 for their customers.
e) It can avoid that waiters get tendinitis as time goes by due to forced and repetitive movements on the nail and the finger. And minimize calluses, cuts and pain in the hands by opening metal lids.
f) It can collaborate also with customers in establishments where the waiters believing that when opening a can 5 for their clients by forcing their nails are collaborating with them, but they are wrong, since most of their customers would like to open their own 5 cans, because they like to check the hygiene of the can personally and thoroughly, and can refuse it if it is visible with traces of dirt or even ask them to be washed, or exchanged, and, even if the cans 5 are not visibly dirty, many customers like to wipe a napkin in the can to make sure it is clean before opening their cans 5, usually because they are used to doing it, and it is not an exaggeration, but a correct attitude, because there have been several cases of death due to by ingestion of feces and urine of rat and other contaminations, in beverage cans 5, but in contrast clients would not like to force their nails in the feat of opening the seal 7 from their cans 5.
g) It can be an opener of threaded lids and can spare clothing and tablecloths that are used to open threaded metal lids of bottles in places where you do not have cloths around.
h) It can be a seasoning sachets S opener using the “ecological cans” seal and minimizing the efforts made with the teeth when the “picks” of the sachets do not work properly, and get rid of ketchup openers everyone gets messed up and may also be contaminated by flies and other insects lured by the food, and contaminated by bacteria due to being hours with products exposed, and still run the risk of not having been well washed by unskilled workers with unsuitable equipment, specially due to the tight geometry that they have.
i) It can be a glass bottle lid opener, for occasions where it is necessary, if using its 2H ring from the keychain 2H described in this patent using the very can seal FIG. 20 and FIG. 21.
j) It could be a whistle where you are to celebrate, alert, or a musical instrument to play a tune with multiple tones.
k) It can even mark your can for not being confused with anyone else at a party, minimizing the risk of catching diseases transmissible through saliva; and
l) It can be squeeze it comfortably whenever you need or want to relax.
m) It can be a zipper puller to jackets for nights out or backpacks, becoming an item that can replace regular zipper pullers forever.
n) Adding up a total of 11 very efficient and precise functions, having many advantages as has been demonstrated herein.

This opener may be in the market soon, being an object (11 in 1) with low cost, and which has 11 functions with simplicity, excellence and with a lot of technological advancement.

This product can be tied or attached in “straw dispensers” in napkins dispensers, in their own tables or other objects easily accessible to shopping facilities, and can be used by waiters in their pockets. (And I believe that personal usage is the best to ensure its hygiene).

The opener can be made with plastics, elastomers and silicones rubbers with additives and nanomaterials screens, rubber and other materials, and can be recycled (contributing with the planet and the environment).

It can have other geometric shapes, which does not compromise or amend its full functioning and just will vary its efficiency and aesthetics for certain functions described here, as long as the operating mechanism remains similar to perform their functions described here with efficiency. And all the different formats such as hexagonal and others, etc., that have been mentioned here have to be able to protect my patent against plagiarism, and so I can preserve my invention, which is actually a functional and technological innovation, and novelty in the state of the art, because I truly invented and created in manually, making numerous prototypes until I got it to work in all the functions described here from function to function.

The non-obviousness and anticipations of matters dealt with in this application can be understood from the concept that is not possible with body (straight pipe) to be used to promote the opening of a lid of a long neck® bottle, especially due to the fact that it does not have any grooves, as anticipated in the object described in the document U.S. 2011/0314968.

Reminding that to open lids this patent 2011/0314968. It needs to be of a rigid material so the lever can work well into the hole, different from my opener in technical and functional characteristics, the process and results as will be shown.

Unlike the object described in the mentioned North-American patent, in this case, the multi-use opener, has its use with regard to opening a threaded lid, based on the flexibility of the material with which it is produced, thus allowing it to be wrapped around the lid aiming at unthreading it, an aspect which is not visually identified when looking and taking the object from all of its other not unidentifiable functions

It is noted that in the case of long neck type bottles (with screw lid) the correct way of removal of this type of lid is required by its spinning, being that if this type of lid is removed by using a lever (as the object described in prior North-American version proposes), there is a risk that when lifting the lid, it scrapes the surface of the claw nozzle, having the possibility of generation of glass particles, a condition which is totally undesirable.

In the present case, the proposed object is not limited to only being used as a simple can or bottle opener and a can opener for threaded lids, different from the existing with more 9 functions that have inventive unit between them and that also features and additionally a huge series of other possibilities for use in a simple and highly technological object in all its technical features previously unreleased, and unseen and multiple functional characteristics.

It should also be pointed out that the object treated in this application combines two seemingly contradictory aspects, which are: a) the fact of having to introduce a flexibility that allows its use for removing the lid of a long neck type bottle, which uses a type of lid that needs to be unscrewed (therefore requiring that the opener is involved around the lid); b) presenting resistance still sufficient and adequate to allow its use as a lever when opening the seal of a beverage can and, additionally, it can be used to open sachets also based on the nature of the flexibility of its structure.

It is noteworthy highlighting that this holder believes that he has developed an object that breaks new ground in the field of the openers, as certainly occurred with the advent of digital phones that have emerged as the evolution of the analog devices.

Still in respect to the function of this opener that can be used to open a sachet, it is not obvious that an essentially tubular element could run such operation, especially when one considers the fact that tubular body may not have conventional cutting elements, and in this case this function can be performed by its own cutting rim still using the properties of the flexibility of its structure coupled with its anti-slip feature (“grip”) feature of elastomers in the hardness mentioned here.

Moreover, being a whistle and a musical instrument that works if bending the tube or pressing laterally to play various tones becoming a multi-tone pan flute in a single tube length also cannot be considered as an obvious feature, especially in conjunction with inventive unit and being a new musical instrument, too.

In order to show the versatility of the object in question, as well as its inventive unit, we will tell a hypothetical history:

We are at a party with the ksplash keychain. We ask for a snack. We wait for the snack squeezing the anti-stress FIG. 23, FIG. 24 on your keychain or zip fastener 2L FIG. 26 jacket and mobile to get the drink, open the can FIG. 6 the long neck with threaded lid FIG. 8 or the Plastic bottle FIG. 7 or the bottle of glass lid T1 FIG. 20 with the seal that is hanging from the locker 2J or along the hoop that holds the zip fastener zipper or mobile zip fastener that the user put it, e.g. as in the case of buying a staple gun and have the clips to work. Getting the snack, we opened the sachet condiments FIG. 15, FIG. 16, FIG. 19 with can seal we took at the time or with the seal that came with it sterilized or from a can we opened a day before, because it gets trapped inside of it should the measurements made for this FIG. 2C or without anything just with their cutting rim which is the micro blade already enough 2D or with the indentation that may have tenths of a millimeter, and we open the sachet.

And when we leave our can unattended, it will be properly identified by the opener stuck in its seal FIG. 25, and then we can dance, and if you want to take it to whistle, FIG. 22A FIG. 22B, to enjoy and have fun at the party.

The narrative above demonstrates the versatility that the object treated in this application presents within a wide range of uses and situations of use, a versatility that is not in any way anticipated by the objects described in the documents pointed out. Having inventive unity and bringing a lot of technological, practical and functional innovation with respect to the known state of the art openers that exist.

1. “MULTIFUNCTIONAL OPENER 21 IN 1”, which is indicated by the numerical reference (2) and is configured as an elliptical tubular (3) body showing a hollow (4) part in its cable (1), wherein the opener (2) is manufactured in materials that can be selected from groups that include enough flexible or semi-flexible materials, as plastics, elastomers, silicones, rubbers, polymers, nanomaterials, and others; the body (1) showing hardness of 80 to 95 Shore A and being able to incorporate grooves (2G), plastic microblade (2D) and can also count with a curved tip (2B).

2. “MULTIFUNCTIONAL OPENER 21 IN 1” according to claim 1, wherein its body (1) incorporates a cutting rim (2D) generated in the manufacture of the present opener.

3. “MULTIFUNCTIONAL OPENER 21 IN 1” according to claim 1, wherein it incorporates at least one region (2F) with less than 80 Shore A hardness throughout its body (1).
